(19) United States
(12) Patent Application Publication
(10) Pub. No.: US 2004/0095936 A1
(43) Pub. Date: May 20, 2004

(54) Classification search scheme and rules engine for network unit

(75) Inventors: Eugene O'Neill, Dublin (IE); Kam Choi, Tring (GB); Paul J. Moran, Hemel (GB)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: 3Com Corporation

(21) Appl. No.: 10/338,170

(22) Filed: Jan. 8, 2003

(30) Foreign Application Priority Data
Nov. 15, 2002 (GB) 0226643.5

(51) Int. Cl. H04L 12/28

(52) U.S. Cl. 370/392

(57) ABSTRACT

A classification search engine for the application of classification rules to a data packet comprises a rules engine for applying a succession of rules, each rule including an operating code. At least some rules are each a single rule of which the operating code specifies a respective portion of the packet, such as a longword, for the extraction of data for the application of the respective rule. Each single rule includes a mask field for controlling the application of the single rule to the data. Other rules are multiple rules of which the operating codes identifies the rule as a multiple rule and which includes a mask for controlling the application of the multiple rule to the results of the application of a multiplicity of single rules to the packet. The operating code for a single rule specifies a pre-determined packet type and a decoder will determine whether a packet conforms to this type (which may be specific or generic) before allowing the application of the rule to the packet.

### FIELD OF THE INVENTION

This invention relates to packet-based communication systems, in which data packets which include address and protocol data are switched and/or routed by network units on a path between a source and a destination or destinations. The invention more particularly relates to a classification scheme, i.e. a method and a classification engine, for determining actions to be taken on packets having regard to selected rules of packet classification.

### BACKGROUND TO THE INVENTION

Network units, by which is principally meant switches and routers or units capable of both bridging and routing, normally comprise a multiplicity of ports for receiving addressed data packets from, and selectively forwarding data packets to, an external network, that is to say to end users or other network units depending on the organisation of the network. Typically, when a packet is received at a port, it is temporarily stored usually in, effectively or actually, a ‘receive’ or ‘ingress’ queue while a look-up in a forwarding database is performed in order, for example, to determine from entries relating destination address data (either media access data or network data) to a port (in the case of a unicast packet) or ports (in case of a multicast packet) should be forwarded. It is well known to ‘populate’ a look-up table relating destination addresses and ports by a variety of means, such as for example data obtained from management packets, making entries relating source addresses with ports on which packets having no source addresses are received, and so on. The use of address look-ups is fundamental to packet switched communication networks.

However, in addition to ordinary address look-ups, it is known to perform a ‘classification’ look-up wherein data which is not confined to destination address data in a packet is related to certain rules, held in a rules database, in order to derive certain actions depending on the criteria, defined by the rules, which the packet might fulfil. If a classification look-up is enabled, the packet will not normally be forwarded until both the ordinary address look-up and the classification look-up have been performed and any forwarding data which would arise from an ordinary address look-up has, if necessary, been modified by virtue of the classification look-up.

In a simple example, a classification look-up may distinguish between packets conforming to TCP (transmission control protocol) and UDP (user datagram protocol) and might be organised so that packets conforming to the latter protocol would not be forwarded by a switch. In such a case, where a look-up based on destination address data would typically produce a port mask defining at least one port from which a packet should be dispatched by the switch, the result of the classification search would produce modification of the port mask to, in this case, modify the port mask to prevent forwarding of the packet to a particular port if the packet conform to a UDP protocol. The modification of the port bit mask might be alteration to specify a different port or adding a port for the purpose of copying a packet.

Classification searches may be employed for a wide and increasing variety of purposes. They may be used both for network security, and what is known as quality of service, or more generally ‘policy control’. For example, quality of service may be based on source addresses of packets and/or TCP/UDP port numbers in order to enhance the quality of service of packet transmission of specified ‘applications’ from specified users. It is furthermore known to inhibit the communication of packets, for example by discard of the relevant packets, where the classification search detects certain types of packets or packets having particular forms of data and so on.

Currently, packets employ a 48-bit destination address field and a 32-bit network destination address field. It is envisaged that address fields can be extended to a greater number of bits, such as 128 bits, in future. However, the width of a classification database is normally much wider. Typically, the width of the classification database is in proportion to the number of bits in the header that can be employed in the classification search. For example, if any field in the first 64 bytes of the packet can be matched, each classification database entry may be 512 bits wide, in addition to a corresponding number of bits that need to be employed in a bitmask for the performance of the classification search.

It is known, for example from EP-1180882-A, to combine classification rules in groups so as to reduce their effective width and make possible the performance of a classification search employing a storage device (particularly a content addressable memory) which is substantially less wide than a classification database which is wide enough to embrace all the fields that might need to be matched against entries in the database. However, it is the general object of the present invention to achieve an efficient classification scheme and in particular to employ a pre-coding scheme to enable a greater variety of combinations of classifiers, whether inclusively or exclusively expressed, and to achieve an efficient transfer from a pre-coding stage to a full classification search.

### SUMMARY OF THE INVENTION

One aspect of the classification scheme is the employment of classification fields, and therefore masking fields, which are substantially shorter than the total width available and which can be used singly or combined in succession to provide a combination of a multiplicity of rules. The width of the classification word could be any desired convenient size but is preferably selected to be a longword, called herein single longword, composed of four bytes; in contrast the segment of packet or associated data available for searching may be at least an order of magnitude wider.

An important feature of the invention is the use of a shorter, operating code, which is conveniently included within a classification field, and which can be used to provide a broad pre-classification of packets into a comparatively small number of groups. Additionally or alternatively the short operating code provides a means of selecting, specifically by specifying offset from a particular point in the segment of packet data, data to be compared (subject to a mask) against a data entry in a classifier word.

A further feature of the invention is the use of a multiple classification word which can operate on a multiplicity, such as a selected succession, of results of single rule comparisons; the different types of classification word can be distinguished by respective operating codes.

Further objects and features of the invention will be apparent from the accompanying drawings.

### BRIEF DESCRIPTION OF THE DRAWINGS

FIG. 1 is a schematic diagram of a network switch.

FIG. 2 is a schematic diagram of a rules engine in accordance with the invention.

FIG. 3 is a schematic diagram of a multiplexing scheme.

FIG. 4 is a flow diagram of a classification search procedure.

### DETAILED DESCRIPTION OF A PREFERRED EMBODIMENT

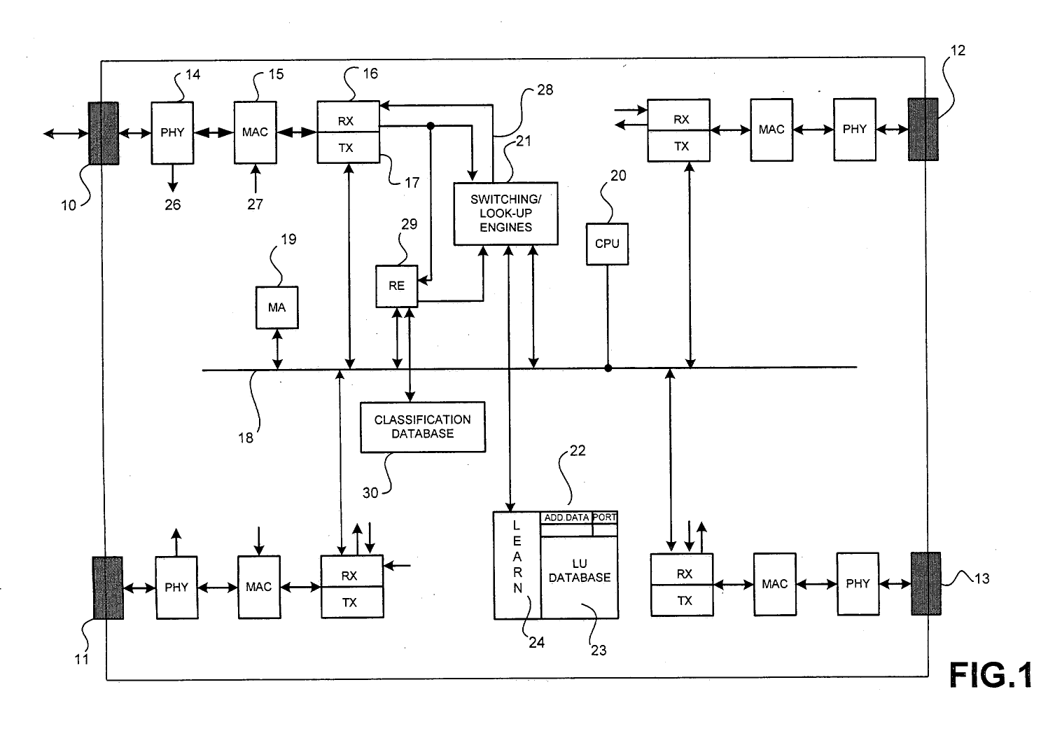

FIG. 1 illustrates the preferred functions of a network unit (called hereinafter ‘switch’) according to the invention. It should be clearly understood that there is a wide variety of switch architectures in which the invention should be employed. Moreover, modern switches and routers are physically exceedingly complex and many of the functions which are explicitly shown, for the sake of simplicity, in FIG. 1 are performed in software.

For example, there is a substantial variation in the organisation of memories. Although FIG. 1 illustrates receive and transmit queues apparently physically located with each input port, network units can employ a system of buffers or a single memory, which may be ‘off-chip’ for the storage of packets during the processing of their headers and so on.

Furthermore, it is readily possibly to construct a unit in the form of a multiplicity of separate modules or chips each of which is associated with a specific multiplicity of ports and which includes its own look-up processing. Each module has a multiplicity of sets of high-speed parallel links by means of which the various parts of the module communicate with each other.

In the exemplary and functionally illustrated switch 1 shown in FIG. 1, the switch is shown as having four ports 10, 11, 12 and 13. More typically a switch would have twelve, twenty-four or even more ports; the specific example described hereinafter for the special header of the packet allows for up to 128 ports on each of eight switches.

As will be described only for the port 10, the other ports having similar provisions, the port 10 is associated with a physical layer device (PHY) 14 which is intended in this example to conform to the physical layer attributes and features set out in IEEE 802.3. Such physical layer devices include the automatic establishment of a link with a link partner by auto-negotiation and the detection of the failure of a link.

Coupled to the PHY 14 is a media access controller (MAC) 15, which, again in this specific example, is intended to conform to the requirements of a media access layer (layer 2) in accordance with IEEE 802.3. The MAC will receive the incoming packet in a media independent form and will perform a variety of features, such as for example flow control and CRC checking, as also described later.

Also associated with this port is memory space shown as an RX memory space 16 and a TX memory space 17. These are schematically intended to illustrate, for the sake of example, a receive (RX) queue of, or defining, packets received at the port and awaiting processing until they are either discarded or transferred across the switch by means of a link table operated in generally known manner by a switching engine. The TX section 17 is intended to represent a queue of packets (or a set of pointers defining packets stored elsewhere in memory) awaiting dispatch from the port 10, which in this example is presumed to be a bi-directional port.

As mentioned, there are similar features 14 to 17 associated with each of the other ports.

The numeral 18 denotes a bus system by means of which the various receive and transmit sections can be communicate with each other and with the various controlling engines to be described. In practice the bus system 18 is substantially more complicated and in general comprises a data path, a control path and a ‘register’ path, the latter being used to convey information derived from management frames to various registers in the switch. However, the layout of the buses and the organisation of management are not directly relevant to a switch according to the invention and are presumed to be within the knowledge of the skilled reader.

Shown as coupled to bus 18 is a management agent (MA) 19 which can receive management frames which are employed to configure and control various registers throughout the switch including the registers which are specific to the present invention.

Also shown as coupled to the bus 18 is a central processor (CPU) 20 which acts in ordinary manner to control and co-ordinate the various operational blocks of the switch. In a practical switch there may be more than one CPU.

Also shown as coupled to bus 18 are switching and look-up engines 21. These are coupled to a database 22.

In an ordinary switch, as mentioned previously, the switching engine will have recourse to a look-up database, shown in FIG. 1 as LU database 23, in order to obtain forwarding data ultimately defining a port or ports from which a packet should be dispatched in accordance with destination address data and possibly various forwarding classification or other rules which may be imposed on the switch as a ‘management policy’ or be determined by forwarding rules and are in any event handled by the switching and look-up engines 21 which for this purpose will operate in ordinary manner.

Also shown as part of the database 22 in FIG. 1 is a ‘learn’ block 24, which represents the customary learning facility of the look-up database. Addresses can be learned against port numbers using the source addresses of received packets. In addition to the usual destination look-up (whether successful or not), a look-up in the database using the source address can be followed by the insertion of an entry if a matching one does not already exist.

Finally, there is shown a rules engine (RE) coupled to a classification database 30. This feature is employed when it is desired to perform classification of input packets employing, for example, layer 4 data or to enforce various rules or combination of rules to determine actions which may have to be taken in response to packets fulfilling a variety of different criteria. The rules engine is coupled to the Rx queue 16 so that it can search specified bits or bytes of a packet header or status information associated with it for correspondence with selected rules. The rules engine 29 will signal to the switching/look-up engines 21 when the classification search is complete. There may be a classification database accessible for all ports or a classification table and rules engine for each port or each of a respective group of ports, depending on the selected architecture. For the sake of example it will be presumed that rules engine 29 and classification database serve only port 10, and operate only on packets in the receive queue constituted or defined by Rx queue 16. The classification database may be ‘split’ into a rules table, in the form of a random access memory, and a rules action table.

For each ingress packet, all valid rules in the table can be searched in sequence for a match. Invalid or unused entries may be skipped. A rule entry that matches the field in the packet may update either an action register for quality of service or a stored action register. The resultant pair of action registers provides an index into a rules action table to identify what ‘QOS’ (quality of service) and ‘AD’ (action decision) actions to take for the packet.

General Summary

A per port ingress classification engine is in the present example capable of examining sixteen ‘longwords’, that is to say 64 bytes of each packet. There are two rule types, called herein QOS and AD action rules. Each rule is associated with a mask to determine which segments, bits or fields of the available longword will be compared with the reference data. A rule may refer to a particular longword or a longword offset or a combination of longwords. Each rule is checked in turn, normally with two results, one relating to quality of service and one to action decision. There may be a default result configured for no match of any of the rules.

Quality of service actions are intended to overwrite DSCP and tag fields in the packet as well as to provide information for forwarding within a stack of units. AD action types are intended to overrule the ordinary forwarding result obtained by the address look-up and may include re-directing to another port in a stack, filtering or copying to another port. In principle, both types of action (QOS and AD) can be programmed for null result, that is to say no action.

Although it is not fundamental to the present invention, which is intended to be applicable to all types of switches and routers, reference is made herein to a ‘cascade’ or ‘stack’. This relates to the disposition of a switch or router in a group of network units which are connected and managed so as to appear to the external network to be a single entity. The grouping of network units in a stack provides a means of effectively providing a single unit with a greater multiplicity of ports than can reasonably be accommodated on a single unit.

In a typical cascade or stack, a look-up performed in a ‘source’ unit, that is to say the first unit that receives a packet within the cascade or stack, may (assuming that the destination is known within the stack) result either in a local forwarding of the packet or a dispatch of the packet over the cascade connection to another unit in the stack which will have the egress port by means of which the packet is forwarding again to the external network. Various types of cascade connections are known in the literature. One is the cascaded stack exemplified by the 3Com Switch 4400, and also the subject of GB patents 2365718 and A further example is a cascade system application wherein a look-up is performed in the source unit and, preferably, the packet is provided with a special header that identifies the egress unit and the egress port from the cascade at least for a unicast packet. On the assumption that the destination unit is not the source unit, the packet is dispatched from a ‘cascade’ port to or towards the destination unit. References herein to a ‘cascade’ port are intended to refer to a port which connects a network unit to one or more other network units which are in a cascade connection and which form a single entity., such as by having a common network address.

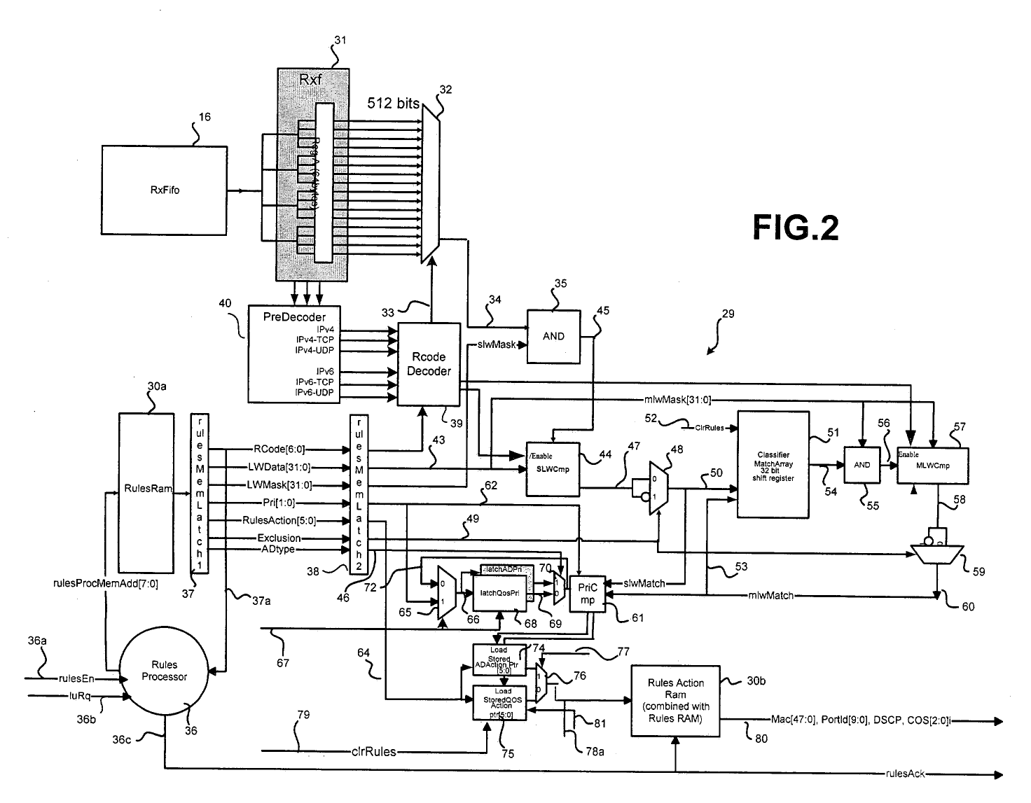

FIG. 2 illustrates a rules engine incorporating the present invention.

The rules engine 29 in FIG. 2 is coupled to a receive FIFO 16 and includes two random access memories, 30a and 30b. The former contains classification ‘rules’ in coded form and the latter contains in coded form various rules actions. The rules engine also includes a rules processor 36, the significance of which will be explained hereinafter.

There follows a discussion of the structure or architecture of the rules engine. The operation of the rules engine and the pre-coding multiplexing arrangements follows thereafter.

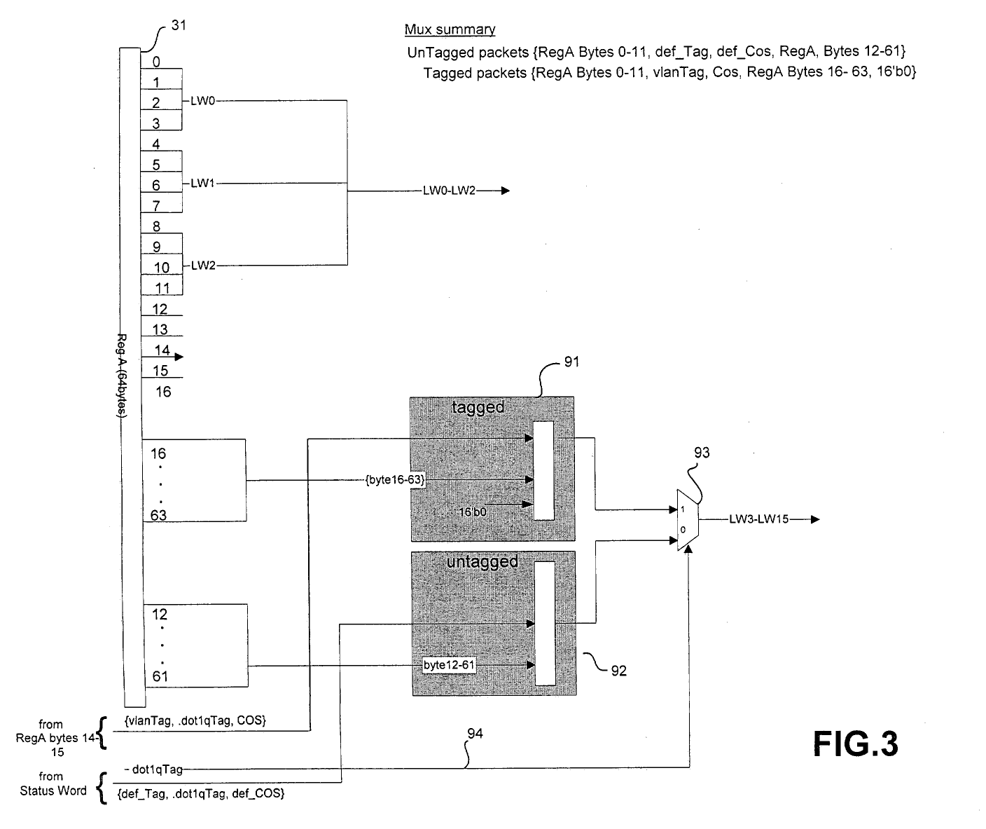

For the engine shown in FIG. 2, 64 bytes relating to a packet temporarily stored in a receive FIFO (RxFIFO 16) can be temporarily stored in a 64-byte register 31. These bytes may be the first 64 bytes of a packet but as explained with reference to FIG. 3, the bytes can be selected from the header and a status word associated with the packet. A ‘longword’ (32 consecutive bits or 4 bytes) can be selected by means of a multiplexer 32. The starting point for the selected longword is determined by a select input 33, which is determined by an Rcode decoder 39 (to be described). The output of the multiplexer 32 leads by way of lines 34 to AND gates 35, comprising thirty-two AND gates in parallel, and controlled by a respective bits of a bitmask, called herein SLW mask, on lines 36. For simplicity here and elsewhere the width of the respective signal is not shown.

Read-out from a RulesRAM 30a is controlled by a rules processor 36 which is enabled by a signal (rulesEn) on a line 36a and is started in a classification search by a signal (LuRq) on a line 36b. This signal will be produced when a packet from the receive FIFO is ready. Completion of the classification search is signalled (e.g. to engines 21) by the rules processor on line 36c.

Successive rules from the RulesRAM 30a can be read out to a first latch 37 which is coupled by a multiplicity of lines to a second latch 38. Various sets of lines from the second rules latch 38 control various gates in the rules engine 29.

The action of the rules processor is to cause successive readout from the RulesRAM until a special Rcode on lines 37a indicates that the rules processor 36 should stop.

The rules output normally comprises a 7-bit Rcode, Rcode[7:0], a 32-bit code denoting longword data, LWData[31:0], a 32-bit mask, LWMask[31:0], a 2-bit priority code, Pri[1:0], a 6-bit action code, RulesAction[5:0], a single ‘inclusion/exclusion’ bit and a single bit type code, AD type, which denotes either a QOS action or an AD action (as explained later).

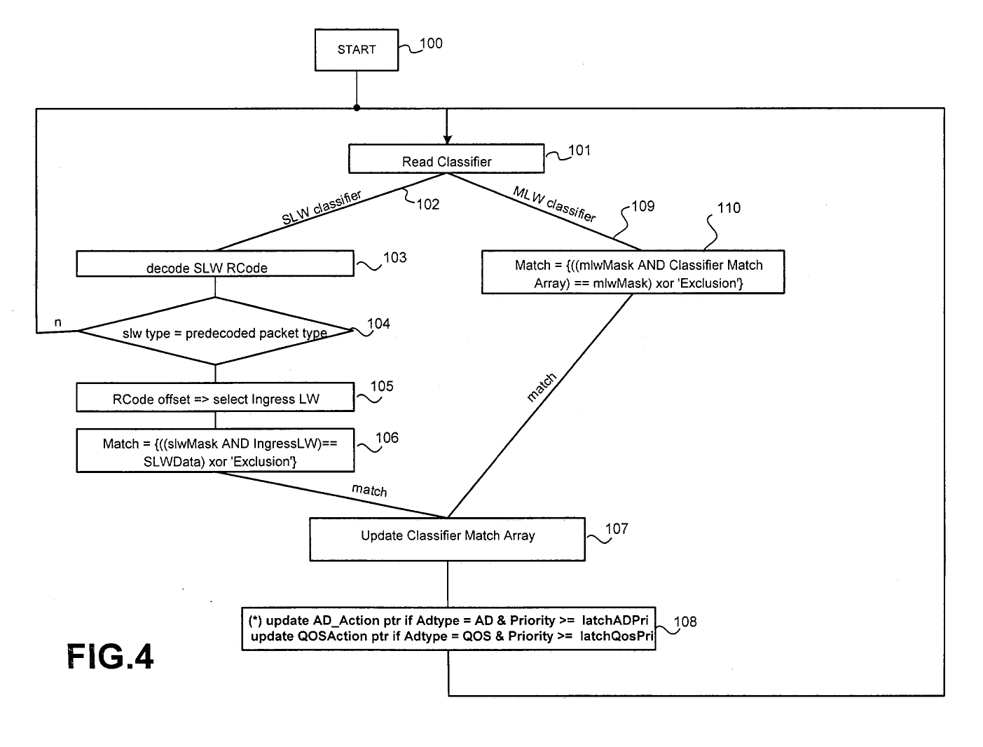

The selected output from the AND gates 35 proceeds on lines 45 to a comparator 44 which compares the selected bits with reference data on lines 43 from the second rules latch 38. Comparator 44 is enabled by the decoder 39. The output from comparator 44 proceeds on lines 47 to gates 48 which are governed by the ‘inclusion/exclusion’ signal on select line 49. Thus the match defined later by stage 106 (FIG. 4) is performed. The output of gates 48 proceeds on lines 50 to a shift register 51. The shift register 51 has output lines 54 coupled to AND gates 55 under the control of the 32-bit mask on the lines 43. The mask is also applied to a comparator 57 which is coupled to the output of AND gates 55 by lines 56 and is also enabled by the decoder 36. The output of the comparator 57 proceeds on lines 58 to gate 59, which has a select line carrying the inclusion/exclusion signal and an output line, denoting a multi longword match, shown by line 60.

The purpose of the shift register 51 is to store an array of results of single longword classification tests. It stores, in this embodiment, the last 32 results. Any selection of these results can be made by the MLWMask, so that a multiplicity of rules can be combined. Examples will be given later. It would be possible to store the results of all the rules in a large array (replacing the 32 bit shift register). It would also be possible to expand each MLW rule entry from a 32 bit mask field to a mask field wide enough to represent each of the preceding rules entry results. However a much wider memory would be required. The solution of storing the most recent 32 rules entry results in a 32-bit shift register provides sufficient variety of choice for practical purposes and employs much reduced memory.

The shift register, AND gates and comparator 57 perform the match defined by stage 110 to be described with reference to FIG. 4.

The results obtained from gates 48 or 59 are employed to update the classifier match array in shift register 51, as also indicated by stage 107 in FIG. 4.

Line 60 extends to a priority comparator 61 which can receive (at different times) either a slwMatch signal from line 50, or a mlwMatch signal on line 60 and an input from a multiplexer 70 (to be described). The purpose of the priority comparator 61 is to compare a priority value stored in one or other of the two priority latches 68 and 69 with the priority value of the control rule (provided on lines 62) and, if the latter value is equal to or greater than the stored value to send a load signal to stores 74 and 75 for an AD action pointer and a QOS action pointer. These stores are connected to receive a RulesAction[5:0] signal on lines 64 but are loaded only under control of priority comparator 61. The selected pointer access the rules action Ram 30b to generate the required output signal (which may be a MAC address, a port identification signal, a DSCP signal or a COS signal on line 80. Output from store 74 or 75 is selected by a multiplexer 76 under the control of a select line 77 receiving the ‘ADtype’ signal. Action registers 75 can be cleared by line 79. QOS Action register 75 may be controlled by the existing COS field of a packet on lines 81.

At the start of packet reception, the Stored QOS action register is pre-armed to a default value indicated by the COS value in the packet (or the Def_COS in the case of an untagged packet.). This pre-arming is indicated by signal 81. When the processing engine reads the “terminate” rules entry, it proceeds to access the AD action entries, both QOS and AD. If no rule is matched for the packet, the default value is used as the QOS action pointer. The priority field, Pri[1:0] is latched into latches 68 and 69 under control of multiplexer 65 and the latched priority is read out by multiplexer 70, controlled by AD type, to priority circuit 61. An initial default priority, in this embodiment 1 (i.e. 01) is set by a line 67.

Pre-Decoding

The decoder 39 responds to the Rcode and in this embodiment to a type signal from a pre-decoder 40 to determine the starting point in the 64 bytes stored in register 31 for the readout of a segment of data, in this embodiment 4 bytes (32 bits) for comparison (if appropriate) under control of the SLWMask with the single longword reference data, LWData[31:0]. The pre-decoder responds to predetermined fields in the packet and/or status word to determine the type and, where a rule has an Rcode (as explained later) denoting a particular predetermined-coded type of packet, will allow the application of the rule to the packet only if the pre-decoding of the packet indicates that it is of that type. The types may be defined in any convenient manner and in general are not mutually exclusive. In the present example, the pre-decoding is into six types, generic versions of IPv4 (Internet protocol version 4) and IPv6 (IP version 6), and each of these as TCP and UDP sub-types. Tables 1 and 2 below illustrate an Ipv4 packet header and an Ipv6 packet header respectively.

TABLE 1

| LW # | | | | | |
|---|---|---|---|---|---|
| 0 . . . 15 | | | | | |
| (offset | | | | | |
| from | | | | | |
| start of | | | | | |
| packet) | Reference | Bit 31 . . . 24 | Bit 23 . . . 16 | Bit 15 . . . 8 | Bit 7 . . . 0 |
| 0 | | MacDa[47:40] | MacDa[39:32] | MacDa[31:24] | MacDa[23:16] |
| 1 | | MacDa[15:8] | MacDa[7:0] | MacSa[47:40] | MacSa[39:32] |
| 2 | | MacSa[31:24] | MacSa[23:16] | MacSa[15:8] | MacSa[7:0] |
| 3 | | Cos[2:0], | Vlan Tag[7:0] | Etype[15:8] | Etype[7:0] |
| | | 1qtag, | | | |
| | | VlanTag[11:8] | | | |
| 4 | LW0-IP | {Ver, HdrLen} | {DSCP, 2′b0} | Len[15:8] | Len[7:0] |
| 5 | LW1-IP | Id[15:8] | Id[7:0] | Frag[15:8] | Frag[7:0] |
| 6 | LW2-IP | TTL[7:0] | Protocol[7:0] | HdrSum[15:8] | HdrSum[7:0] |
| 7 | LW3-IP | IPSa[31:24] | IPSa[23:16] | IPSa[15:8] | IPSa[7:0] |
| 8 | LW4-IP | IPDa[31:24] | IPDa[23:16] | IPDa[15:8] | IPDa[7:0] |
| 9 (*) | LW0-L4- | SrcPort[15:8] | SrcPort[7:0] | DstPort[15:8] | DstPort[7:0] |
| | TCP/UDP | | | | |
| 10 | LW1-L4- | Seq[31:24] | Seq[23:16] | Seq[15:8] | Seq[7:0] |
| | TCP | | | | |
| | LW1-L4- | Length[15:8] | Length[7:0] | Chksum[15:8] | Chksum[7:0] |
| | UDP | | | | |
| 11 | LW2-L4- | Ack[31:24] | Ack[23:16] | Ack[15:8] | Ack[7:0] |
| | TCP | | | | |
| | LW2-L4- | Payload LW0 (++) | | | |
| | UDP | | | | |
| 12 | LW3-L4- | HdrLen[3:0] | Code[6:0] | Window[15:8] | Window[7:0] |
| | TCP | | | | |
| | LW3-L4- | Payload LW1 (++) | | | |
| | UDP | | | | |
| 13 | LW4-L4- | TcpChk[15:8] | TcpChk[7:0] | Pointer[15:8] | Pointer[7:0] |
| | TCP | | | | |

| | | |
|---|---|---|
| | LW4-L4- | Payload LW2 (++) |
| | UDP | |
| 14 (+) | LW5-L4- | Payload LW0 (++) |
| | TCP | |
| | LW5-L4- | Payload LW3(++) |
| | UDP | |
| 15 | LW6-L4- | Payload LW1(++) |
| | TCP | |
| | LW6-L4- | Payload LW4(++) |
| | UDP | |

TABLE 2

| LW # | | | | | |
|---|---|---|---|---|---|
| 0 . . . 15 | | | | | |
| (offset | | | | | |
| from | | | | | |
| start of | | | | | |
| packet) | Reference | Bit 31 . . . 24 | Bit 23 . . . 16 | Bit 15 . . . 8 | Bit 7 . . . 0 |
| 0 | | MacDa[47:40] | MacDa[39:32] | MacDa[31:24] | MacDa[23:16] |
| 1 | | MacDa[15:8] | MacDa[7:0] | MacSa[47:40] | MacSa[39:32] |
| 2 | | MacSa[31:24] | MacSa[23:16] | MacSa[15:8] | MacSa[7:0] |
| 3 | | Cos[2:0], | VlanTag[7:0] | Etype[15:8] | Etype[7:0] |
| | | 1qtag, | | | |
| | | VlanTag[11:8] | | | |
| 4 | LW0-IPv6 | {Ver, traffic | {traffic | flow label[15:8] | flow label[7:0] |
| | Traffic | class[7:4]} | class[3:0], flow | | |
| | class[7:2] = IpV4 | | label[19:16]} | | |
| | {DSCP[5:0]} | | | | |
| 5 | LW1-IPv6 | payload length | payload length | Next | Hop limit[7:0] |
| | | [15:8] | [7:0] | Header[7:0] | |
| 6 | LW2-IPv6 | IPSa[127:120] | IPSa[119:112] | IPSa[111:104] | IPSa[103:96] |
| 7 | LW3-IPv6 | IPSa[95:88] | IPSa[87:80] | IPSa[79:72] | IPSa[71:64] |
| 8 | LW4-IPv6 | IPSa[63:56] | IPSa[55:48] | IPSa[47:40] | IPSa[39:32] |
| 9 | LW5-IPv6 | IPSa[31:24] | IPSa[23:16] | IPSa[15:8] | IPSa[7:0] |
| 10 | LW6-IPv6 | IPDa[127:120] | IPDa[119:112] | IPDa[111:104] | IPDa[103:96] |
| 11 | LW7-IPv6 | IPDa[95:88] | IPDa[87:80] | IPDa[79:72] | IPDa[71:64] |
| 12 | LW8-IPv6 | IPDa[63:56] | IPDa[55:48] | IPDa[47:40] | IPDa[39:32] |
| 13 | LW9-IPv6 | IPDa[31:24] | IPDa[23:16] | IPDa[15:8] | IPDa[7:0] |
| 14 | LW0-IPv6-L4- | SrcPort[15:8] | SrcPort[7:0] | DstPort[15:8] | DstPort[7:0] |
| | TCP/UDP | | | | |
| 15 | LW1-IPv6-L4- | Seq[31:24] | Seq[23:16] | Seq[15:8] | Seq[7:0] |
| | TCP | | | | |
| | LW1-IPv6-L4- | Length[15:8] | Length[7:0] | Chksum[15:8] | Chksum[7:0] |
| | UDP | | | | |

Whether a packet is IPv4 or IPv6 is denoted by the Etype field. For an IPv4-TCP packet, IPv4 and IP protocol=0×6 and IP header field ‘MF’ field=0 and IP header ‘fragment’ field=0 (i.e. no fragments are allowed). For an IPv4-UDP packet IPv4 and IP protocol=0×17, IP header ‘MF’ field and IP header ‘fragment’ field=0.

For an IPv6-TCP packet, IPv6 and IPv6 ‘Next Header’=0×6. For an IPv6-UDP packet, IPv6 and IPv6 ‘Next Header’=0×17.

Tagged and Untagged Packets

FIG. 2 shows (for the sake of example) that the first 64 bytes of a packet are made available to the multiplexer 32. In practice most of the first 64 bytes along with some other information from the packet is read into register 31, as shown in FIG. 3. The selected information varies for packets having or not having a tag according to IEEE 802.1q. For packets having such a tag it is possible (in order to avoid unnecessary duplication of operating circuits) to employ the tag, retrievable from the packet held in the FIFO 16a, to control the selection. In particular, the selection of bytes from an untagged packet may comprise bytes 0 to 11 from register 31, the def_Tag, def_Cos and bytes 12 to 61 from register 31. For a tagged packet the selection is bytes 0 to 11 from register 31, the vlanTag, the Cos field, bytes 16 to 61 from register 31 and a 16′b0 value. The first 12 bytes [0 to 11] are common and provided as longwords LW0 to LW2 to the multiplexer 32. Registers 91 and 92 receive the bytes for the tagged and untagged selection and one or other is selected by multiplexer 93 according to the 1q tag on line 94. The bytes thereby selected provide longwords LW3 to LW15.

Classification Search

Before examples of classification searches are given, reference is first made to FIG. 4 which is a broad overview of the search process.

From a start, stage 100, there is first a reading (stage 101) of the classifier from the RulesRAM 30a. From the short code, i.e. the Rcode described later there will be a determination of the broad action required and in particular whether the classifier is a single longword classifier (102) or a multiple longword classifier (109). The Rcode may define other types such as an unused classifier or no classifier (as when the Rcode defines the cessation of the search). If the Rcode denotes an SLW classifier, it is decoded. If the slw type matches a pre-decoded type the Rcode offset is used (stage 105) to select the ingress longword. If there is no match the next classifier is read. The single longword match is shown in stage 106. The classifier match array is updated (stage 107) and if the priority value is equal to or greater than the latched priority the appropriate action pointer (in store 74 or 75) is updated (stage 108), depending on the state of ADType=QOS or AD.

If the classifier is a multiple longword classifier (109), the match defined in stage 110 is performed. The updating of the classifier match array and possible updating of the action pointer (stages 107 and 108) follow.

One aspect of the classification scheme is the employment of classification, and therefore masking, fields which are substantially shorter than the total width available and which can be used singly or combined in succession to provide a combination of a multiplicity of rules. The length of the classification word could be any desired convenient length but is preferably selected to be a longword, called herein single longword, composed of four bytes.

An important feature of the invention is the use of a shorter code, which is conveniently included within a classification field, and which can be used to provide a broad pre-classification of packets into a comparatively small number of groups and also to provide a means of selecting, specifically by specifying offset from a particular point in the packet, the data to be compared against the data entry in the classifier code.

The use of the short code, called herein Rcode, is useful for a variety of reasons. In particular, most classifying requirements are for a particular type or for a small number of particular types of packet, in particular IPv4 or IPv6 (Internet protocol version 4 or Internet protocol version 6) packets, TCP (Transmission Control Protocol) or UDP (User Datagram Protocol) type packets. An efficient way of organising classifying resources is therefore to provide a stage of pre-decoding to identify packet types IPv4 and IPv6 along with IP protocols of TCP or UDP. Accordingly, the classification database entries can be divided into different types, particularly IPv4, IPv4 with TCP protocol, IPv4 with UDP protocol and the equivalent decoding for IPv6 packets. A generic type may be included for packets other than these packet types. Only packets that match a pre-decoding stage may be considered for matching against a particular classifier.

A single longword classifier entry is shown in Table 3.

TABLE 3

| Field. | Description |
|---|---|
| SLWData[31:0] | 32 bits of data to be compared |
| SLWMask[31:0] | SLW mask to be applied to selected 32 bits of data |
| | (called IngressLW). Result is compared with |
| | SLWData. The compare function is as follows: |
| | {((SLWMask AND IngressLW) == SLWData) |
| | xor ‘Exclusion’ = Match} |
| Inclusion/Ex- | Inclusion/Exclusion flag. Inclusion = 0, Exclusion = 1. |
| clusion | Used to indicate whether the classifier is an inclusion |
| | or exclusion type rule. |
| Rcode | Rcode |
| | (SeeRCode Table) |
| Priority[1:0] | To resolve conflicts, if more than 1 classifier matches. |
| | 00 is used as ‘Null-action’. 3 priority levels 1, 2 |
| | and 3. Priority latch holds most up to date value. Set to |
| | 1 at start of packet. |
| Action Pointer | Result pointer to “action table”. Action Pointer is |
| [5:0] | updated if a Match is generated for a classifier and the |
| | Priority code is greater than the current value in |
| | Priority Latch. |
| ADType | 0 = QOS rule |
| | 1 = AD rule |
| | If ADType = 0, the QOS priority latch and the stored |
| | QOS action Ptr is checked. |
| | If ADType = 1, the AD priority latch and the stored |
| | AD action Ptr is checked. |

As is shown in Table 3, the classifier entry, which at each stage of the classification cycle is read out from the RulesRAM by the rules engine, is composed, in this embodiment, of seven fields.

The first field is a longword (32 bits) of data which define the data against which the data selected from the ingress packet must match. The second field is a 32-bit field, namely a field defining a mask, which is applied to the selected bits of data in the ingress longword. As will become apparent later, the comparison function is defined, for each bit, as (SLWMask AND IngressLW)==(SLWData) xor ‘Exclusion’=Match.

The third field is a 1-bit field constituting an inclusion or exclusion flag. This indicates whether the classifier is an inclusion type rule or an exclusion type rule.

The fourth field is a 7-bit Rcode, described with reference to Table 5.

The fifth field is a 2-bit priority field which is provided to resolve conflicts if more than one classifier provides a match. 00 is employed as a null action. The other three values provide three priority levels.

The sixth field is a Rules action pointer to an action table. The QOS or AD action pointer will be updated (depending on the ADType value) if the priority code is greater than or equal to the current value in the QOS or AD priority latch.

The last field denotes the AD type, which is zero for a QOS rule and 1 for an action decision rule.

It is convenient at this point to describe the multiple longword classifier. This is shown in Table 4.

TABLE 4

| Field. | Description |
|---|---|
| MLWMask | 32 bit MLW mask. This field is compared with the 32 bit |
| | Classifier Match Array (which reflects the results of the |
| | previous 32 classifier entries). |
| | A bit set to 1 in the MLWMask indicates that the cor- |
| | responding bit in the 32 bit Classifier Match Array is |
| | checked for a logic 1. A bit cleared in the MLWMask field |
| | implies that the bit in the Classifier Match Array is |
| | ignored. |
| | The logic to generate match is as follows: |
| | {((MLWMask AND Classifier Match Array) == |
| | MLWMask) xor ‘Exclusion’ = Match} |
| Inclusion/ | Inclusion/Exclusion flag. Inclusion = 0, Exclusion = 1. |
| Exclusion | Used to indicate whether the classifier is an inclusion or |
| | exclusion type rule. |
| Rcode | Rcode |
| | (SeeRCode Table) |
| Priority[1:0] | To resolve conflicts, if more than 1 classifier matches. |
| | 00 is used as ‘Null-action’. 3 priority levels 1, 2 and 3. |
| Action | Result pointer to “action table”. Action Pointer is updated |
| Pointer | if a Match is generated for a classifier and the Priority code |
| | is greater than the current value in Priority Latch. |
| ADType | 0 = QOS rule |
| | 1 = AD rule |
| | If ADType = 0, the QOS priority latch and the stored QOS |
| | action Ptr is checked. |
| | If ADType = 1, the AD priority latch and the stored AD |
| | action Ptr is checked. |

The multiple longword classifier has six fields, beginning with a 32-bit mask. This field is compared with the 32-bit classifier match array, which reflects the results of the previous 32-bit classifier entries. A bit set to 1 in the multiple longword mask indicates that the corresponding bit in the 32-bit classifier match array is checked for a logic 1. A bit cleared in the multiple longword mask field implies that the bit in the classifier match array is ignored. The logic to generate a match is as follows:

MLWMask AND Classifier Match Array==MLWMask xor ‘Exclusion’=Match.

The remaining fields are an inclusion/exclusion field, an Rcode, a 2-bit priority field an action pointer and an AD type which are similar to those used in the single longword classifier.

Table 5 illustrates by way of example the Rcode fields, which in this example are of ten different types each denoted for the sake of explanation by a respective letter A to J.

TABLE 5

| Rcode[6:0] | Category | |
|---|---|---|
| 0000000 | unused entry (Nop) | A |
| 0001000 | terminating entry | B |
| 0010000-0011111 | Generic-Single field (SLW-G) | C |
| Bits[3:0] indicate Longword offset | | |
| from start of packet. Maximum | | |
| offset is 16 Longwords. Any | | |
| Longword in first 64 bytes | | |
| specifiable. | | |
| 0100000-0101011 | IP Single field (SLW-IPv4) | D |
| Predecoded as IPv4 packet. | | |
| Longword offset from start of IP | | |
| header, as indexed by Rcode[3:0]. | | |
| Maximum offset is 12 Longwords. | | |
| 0110000-0110110 | L4 Single LW field | E |
| Predecoded as TCP packet. | (SLW-IPv4-TCP) | |
| Longword offset from start of | | |
| TCP header, as indexed by | | |
| Rcode[2:0]. Maximum offset is | | |
| 7 Longwords. | | |
| 0111000-0111110 | L4 Single field (SLW-L4-UDP) | F |
| Predecoded as UDP packet. | | |
| Longword offset from start of | | |
| UDP header, as indexed by | | |
| Rcode[2:0]. | | |
| Maximum offset is 7 | | |
| Longwords. | | |
| 0111111 | Multi field (MLW) | G |
| 1100000-1101011 | IPv6 Single field (SLW-IPv6) | H |
| Predecoded as IPv6 packet. | | |
| Longword offset from start of | | |
| IPv6 header, as indexed by | | |
| Rcode[3:0]. | | |
| Maximum offset is 12 | | |
| Longwords. | | |
| 1110000-1110001 | L4 Single field | I |
| Predecoded as TCP packet. | (SLW-IPv6-TCP) | |
| Longword offset from start of | | |
| TCP header, as indexed by | | |
| Rcode[2:0], | | |
| is compared. | | |
| 1111000-1111001 | L4 Single field | J |
| Predecoded as UDP packet. | (SLW-IPv6-UDP) | |
| Longword offset from start of | | |
| UDP header, as indexed by | | |
| Rcode[2:0], | | |
| is compared | | |

Rcode field A, all zeros, is an unused entry which will be skipped by the search engine.

Rcode field B is a terminating entry which indicates the end of the search.

The Rcode field C is a generic single field entry. The first three bits [7:5] denote the generic type and the last five bits [4:0] indicate the offset of the beginning of the single longword from the start of the packet. The offset can be up to sixteen longwords.

Rcode field D denotes a single field classifier for IP packets type IPv4 and this Rcode will pre-decode IPv4 packets. The maximum offset is twelve longwords from the start of the packet.

Rcode field E provides pre-decoding of IPv4-TCP packets and provides an offset from the start of the TCP header as indexed by Rcode [2:0]. The maximum offset is seven longwords.

Rcode F provides a pre-decode of IPv4-UDP packets and an offset from the start of UDP header.

Rcode G, a zero followed by seven ones, denotes a multi-field classifier which does not require an offset.

Rcode H provides the pre-decoding of IPv6 packets and an offset of up to twelve longwords from the beginning of the IPv6 header.

Rcode I provides pre-decoding of IPv6-TCP packets.

Rcode J provides pre-decoding of IPv6-UDP packets.

It will be noticed that in each case, except for the codes A, B and G, denoting an unused entry, the terminating entry and the multi-field identifier, the Rcode extends over a range. This is because in each case the least significant portion indicates a selectable offset.

Detailed Description of Classification Process

(a) As previously noted, the RulesRAM 30 port is split into a rules table 30a and a rules action table 30b. For each ingress packet, all valid rules in the table are searched in sequence for a match. The Rcode determines the starting point for a comparison of a selected longword with the reference data (LWData) under control of the respective mask. The mask need not prescribe a comparison for every bit. If there is a match, denoted for a single longword by the output from gate 48, the engine may update either a StoredQOSAction register or a StoredADAction register. The resultant pair of action registers provides an index into the Rules action table to identify what QOS and AD actions to take for the packet, L2/L3 QOS remarking, redirecting to another port etc.

(b) The Ram 30 has 256 entries. It is assumed that the first 192 entries (30a) are used for rules, of various types and the bottom 64 entries of the Ram (30b) are used for Rules action entries.

(c) 64 bytes from the packet header and possibly its status word are stored as sixteen longwords (LW) in register 31.

(d) As described with reference to FIG. 3 there is muxing for the VLAN Tag field. It involves muxing the default vlan tag to the classifier, for LW3. This allows tagged and untagged packets to have the same longword definitions to the classifier. The VLAN Etype is omitted. This also allows the muxing of the IP header to start on a LW boundary. The default per port VLAN tag (in the packet status word) is used for untagged packets.

(e) The rules are broken into two categories: Single longword rules (SLW) and combinations of single longword entries called multi-longword entries (MLW). MLW rule matches can include a mix of already matched SLW and MLW rules.

(f) Each SLW rule is 32 bits wide, i.e. much shorter than the full width of the header and other information in register 31. After individual LWs are matched several longwords can be combined in a further MLW search.

(g) Single longword (SLW) rules involve comparison of a certain LW. The LW offset is specified as part of the Rcode. Single longword rules can include a stage of pre-decoding of the packet header first for the most common packet types i.e Ethernet-II format, IPv4 packets (SLW-IP), TCP packets (SLW-L4-TCP), UDP packets (SLW-L4-UDP) and IPv6 packets (SLW-IPv6), TCP packets (SLW-IPv6-L4-TCP), UDP packets (SLW-IPv6-L4-UDP). Only if this stage is passed is the comparison performed. A default SLW entry could be configured by setting LW mask in rule=32′h00000000 and LW data in rule entry=32′h00000000. Effectively each bit of the LW muxed from regA is ‘knocked out’ and this rule will always match.

(h) There are three main types of SLW entries, Generic, IPv4 and IPv6. The IPv4 and IPv6 entries have two further sub-categories, i.e. TCP and UDP.

A single longword-generic (SLW-G) search is for a pattern in a specific LW entry. An example of a single longword generic match is bits (31:24+7:0) of LW1. Another example is a match of bits (7:0) of LW8 the IPDA (internet protocol destination address).

A IPv4 (SLW-IP) search starts from (i.e. is offset from) the start of the IPv4 header. Each LW can be searched, e.g. LW3 can be searched for an IP source subnet address match. LW0-IP can be checked for a DSCP value.

A single longword-L4-TCP (SLW-L4-TCP) search starts from the start of the TCP header in an IPv4 packet. Each LW can be searched, e.g. LW0 can be searched for a TCP source port match. LW3-L4-TCP can be checked for a TCP RST flag.

A single longword-L4-UDP (SLW-L4-UDP) search starts from the start of the UDP header in an IPv4 packet. Each LW can be searched, e.g. LW0 can be searched for a UDP source port match.

A single longword-IPv6 (SLW-IPv6) search is offset from the start of the IPv6 header. Each LW can be searched, e.g. LW0-IPv6 can be searched for a flow label match. LW0-IPv6 can be checked for a DSCP (Traffic Class) value.

A single longword-IPv6-L4-TCP (SLW-IPv6-L4-TCP) search starts from the start of the TCP header in an IPv6 packet. Each LW can be searched, e.g. LW0 can be searched for a TCP source port match.

A single longword-IPv6-L4-UDP (SLW-IPv6-L4-UDP) search starts from the start of the UDP header in an IPv6 packet. Each LW can be searched, e.g. LW0 can be searched for a UDP source port match.

(i) The RuleMatchArray (shift register 51) stores the ‘match’ status of a multiplicity of (in this case 32) successive rules and is continually updated as rules are compared. Each rule that matches (either SLW or MLW rules) sets the first bit in the RuleMatchArray, as the array is shifted by one bit. This 32-bit RuleMatchArray is used to compare against each MLW rule mask field. This allows any subset of the previous 32 rules (SLW or MLW) to be further combined in a MLW rule. If a bit in the mask field of the MLW rule is set, the corresponding bit in the RuleMatchArray is checked to see if it is ‘set’. If the bit in the mask field of the MLW rule is ‘clear’, the status of the corresponding bit in the RuleMatchArray is ignored. This logical operation is summarised as follows: the 32-bit mask field in an MLW rule is first ‘anded’ with the RuleMatchArray and the result is compared with the Mask Array. {((RuleMatchArray[31:0] ‘ANDed’ MLW mask field) ‘==’ MLW mask field)=>match.} The MLW rules have their own Rules action entry.

A first example is given by the following four SLW entries for W, X, Y, Z to be combined in a MLW rule as (W AND X AND Y AND Z) (MLW#1). Another three SLW entries A, B, C are combined in another MLW#2 rule as (A AND B AND C). Another MLW#3 rule combines the two previous rules (MLW#1 AND MLW#2).

(j) It is possible to have rule entries (SLW and MLW) that are used to update the RuleMatchArray only. These rules do not directly update the QOS or AD action result. This implies these rules are combined in a later MLW rule only. To ensure that such rules do not update either the QOS or AD Action result registers, the Pri[1:0] field of such rule entries is set to 0. Such entries are called ‘no-action’ entries.

(k) The SLW and MLW rules have an inclusion/exclusion flag also in the database. If the flag is set for a rule, it indicates an exclusion type match e.g. everything except this value causes a match. This is useful for ACL (access control list) type rules. An example of a MLW rule using exclusion rules is four SLW entries W, X, Y, Z, with X and Z entered as SLW exclusion entries, combined in a MLW rule (call this MLW#4) as (W AND NOT X AND Y AND NOT Z). Another MLW rule (MLW#5) could be (A AND B and NOT C), where A & B are ‘inclusion’ SLW rules and C is an ‘exclusion’ SLW rule. The MLW#4 and MLW#5 can be further combined as (NOT MLW#4 AND MLW#5) where MLW#4 is an exclusion MLW rule.

(l) To generate the ‘match’ result for a rule, the previously described ‘match’ operation is conditioned with an XOR operation. For an SLW rule the operation is: {((RuleMatchArray[31:0] ‘ANDed’ MLW mask field) ‘==’ MLW mask field) XOR Exclusion flag=>match}. The corresponding MLW operation is as follows: {((RuleMatchArray[31:0] ‘ANDed’ MLW mask field) ‘==’ MLW mask field) XOR Exclusion flag=>match.} It is this match value that is entered into the RulesMatchArray.

(m) In order to implement OR type rules, e.g. W or X or Y or Z type rules, W, X, Y and Z can be entered as separate SLW entries all pointing to the same action entry.

(n) Combinations of AND and OR type rules can be implemented as follows e.g. (X AND Y) OR (A AND B). Here X, Y, A, B are all SLW rules. X AND Y are combined as a MLW rule. A AND B are combined as a MLW rule. The OR function is implemented as two MLW rules referring to the same action entry. A more complicated AND and OR type rule is (X or Y) and A and B. Here one MLW rule combines (X and A and B), and another MLW rule is (Y AND A AND B). These two MLW entries point to the same action entry.

(o) Unused entries in the database have the Rcode[6:0]=0000000 (NOP). An end of search indicator Rcode[6:0]=0001000, is used to terminate the search.

(p) Database entries (both SLW and MLW) have a 2-bit priority field (Pri) that is used when more than one rule matches a particular packet. A QOS Pri[1:0] status and an AD Pri[1:0] status are continually maintained by the search engine in priority latches 68 and 69. Both QOS Pri and AD Pri are preset to ‘01’ at the start of each packet. Effectively there are three priorities (1, 2, 3). Pri[1:0]=‘00’ value is assigned to rules that are used to update the RulesMatchArray only i.e. ‘No Action’ type rules. When a rule is fetched and a ‘match’ is generated, the Pri[1:0] field is compared with either the QOS Pri or the AD Pri (depending on the Rule Type flag). For a QOS type rule if the Pri field is ‘>=’ the QOS Pri latch status in the rules engine at the compare time, the QOS Pri latch and the stored QOS Action register is updated. For a AD type rule if the Pri field is ‘>=’ the AD Pri status latch in the rules engine at the compare time, the AD Pri latch and the stored AD Action register is updated. Only one QOS action and one AD Action field is selected at the end of all the different rule searches. If more than one entry in the database match a particular packet, the highest priority is taken. If more than one matching rule has the same priority, the Rules action from the last match is taken.

(q) The search engine starts at location zero in the table and reads each subsequent entry, jumping over unused (Nop) entries (Rcode[6:0]=0000000) until it finds the terminating Rcode value (Rcode [6:0]=0001000.

(r) QOS-Default entries. If there is no QOS rule match in the table, a default QOS action entry is selected. There are eight QOS action entries reserved for defaults, i.e. entries 56 to 63 of the action table. These default entries are selected based on the SrcCOS[2:0] value in LW3. The Cos[2:0] field is equivalent to the 802.1p value in 1q tagged frames. Otherwise it is a default per port assignment. Front panel ports would normally be expected to have a default QOS entry per port. However on the cascade ports there should not be any QOS action (not even default QOS action). As there is no way of preventing the COS field in the status word from being updated, it is necessary to configure all eight default QOS entries to map to the same COS value, if no QOS action is required. In this situation the hardware simply overwrites the COS field in the status word with the same value, implying no change.

(s) AD Default entries. If there is no AD rule match in the table, a default AD action entry is selected. There may be one AD action entry reserved for defaults. The AD_Action status could be preset to this entry 55 at the start of each packet.

(t) Any packet with a CrcError should not be examined by the rules engine. Such a packet can be filtered out by the forwarding engine.

(u) The rules engine can ignore ‘exception’ packets (e.g. ARP packets) if snooping is enabled for that exception.

(v) The rules engine can be enabled/disabled at any stage without disrupting packet flow through the system.

Normally a default set of rules is entered in the table when the device is initially configured. However new entries may be added during normal operation and entries present can be reconfigured or deleted. These modifications can occur during normal packet forwarding, without disabling the rules engine. However if the entire table has to be refreshed, it is possible to disable/re-enable the rules engine without disrupting normal packet forwarding (excepting that rules actions will not be implemented during the disabled period)

Modifying the Rules Table During Normal Packet Forwarding

Take the case of a new rule that requires two SLW entries combined into one MLW entry. Take the following steps:

1. Before inserting the new rule, the action entry should be entered in the relevant table.

2. Insert a new “Termination entry” at three locations after the previous one. Including the Terminating entry the next three locations should be used for the new rules. Set the Rcode of the three new rules to ‘NOP’ temporarily.

3. The first two SLW entries and the MLW entry are added to the three locations, starting from the previous terminating entry. As the rules are added, ensure the Rcode is set to NOP.

4. The MLW rule is added pointing to the already configured action entry.

5. Update the Rcode for the new SLW and MLW entry to the appropriate code (from NOP).

It is preferable to set the Rcode of an entry to NOP when starting to modify the entry. However when updating/modifying an existing rules entry, consideration can be given to whether the change can be accomplished in one single CPU write cycle. If so, then the change can be made without disabling the entry. For example, if the ‘Rules action’ has to be changed, the CPU can write to LW2 for that entry with the updated ‘Rules Action’ along with the other fields. If more than one LW has to be changed, the Rcode for that entry should be first set to ‘NOP’. The rules engine will then ignore that entry. After the changes are made to the rule, the Rcode is set to the correct value again. Note: the Rcode field is shared (same Longword) with the ‘Pri’, ‘Rules Action’ and ‘inclusion/exclusion’ fields.

When updating an action entry, the following steps should be taken: If only one LW write operation is required to update an action entry, it is possible to update an action entry on the fly. However, consider the case of changing the RulesMacDA field for a web cache redirect type rule. The following steps should be taken: Copy the Action entry to a new (free) entry and modify the fields as required. Then re-programme all the rules that point to the old entry to point to the new entry. The ‘Rules Action’ field can be programmed in one write operation, without disabling that rule entry.

When updating a rule to point to another action entry or simply entering NOP for that rule, the associated action entry that is ‘freed up’ can be modified by the CPU after 1 us has elapsed. This ensures that the current packet that was being searched has been cleared from the system.

Disabling the Rules Engine During Normal Packet Forwarding

The Rules engine can be enabled or disabled during normal operation, without effecting packet transfer through the switch. The rules engine will complete the current packet and then go to idle. While in the idle state all rules actions are suspended.

After refreshing the rules table, the CPU can enable the rules engine again. The rules engine would wait until the start of the next packet to start the per packet search/processing again.

1. A classification search apparatus for a network unit which is operative to receive and forward addressed data packets, comprising:
a temporary store for a segment of data relating to a received packet;
a store for classification rules at least some of which include a field of reference data and an operating code, said operating code defining a starting location in said segment for a packet data field to be compared with said reference data; and
a rules engine for applying a multiplicity of said classification rules for successive application to said segment of data.

2. Apparatus according to claim 1 wherein each of said classification rules includes a mask field for controlling comparison between said reference data and said packet data field.

3. Apparatus according to claim 1 wherein at least some of said classification rules each have an operating code identifying a predetermined type of packet.

4. Apparatus according to claim 3 and further comprising means for determining whether the packet conforms to said predetermined type before allowing the application of a classification rule to the packet data field.

5. Apparatus according to claim 1 wherein at least one classification rule comprises an operating code which indicates termination of a classification search.

6. Apparatus according to claim 1, further comprising a storage array for storing the results of the application of a multiplicity of classification rules to selected data fields in said segment; and wherein said rules engine applies a multiple rule to said results.

7. Apparatus according to claim 6 wherein said storage array stores a limited succession of said results.

8. Apparatus according to claim 6 wherein said multiple rule comprises a mask field for application to said results and an operating code distinguishing the multiple rule.

9. Apparatus according to claim 1 wherein at least some of the rules each include a field indicating whether the respective rule is an inclusion rule or an exclusion rule.

10. A classification search engine for the application of classification rules to a data segment, comprising:
a rules engine for applying a succession of rules, each rule including an operating code, wherein:
at least some of said rules are each a single rule of which the operating code specifies a portion of said data segment for the extraction of data for the application of the respective rule, each single rule including a mask field for controlling the application of the single rule to said data segment; and
at least one rule is a multiple rule of which the operating code identifies the rule as a multiple rule and which includes a mask for controlling the application of the multiple rule to the results of the application of a multiplicity of single rules to the packet.

11. A classification search engine according to claim 10 wherein the operating code for each single rule identifies a predetermined packet type.

12. A classification search engine according to claim 10 wherein the operating code of each single rule specifies a selectable offset from a reference point in the segment.

13. A classification search engine according to claim 10 wherein at least some of the rules each include a field indicating whether the respective rule is an inclusion rule or an exclusion rule.

14. A classification search engine for the application of classification rules to a data segment including data from a data packet, comprising:
a rules engine for applying a succession of rules, each rule comprising an operating code, wherein:
at least some rules are each a single rule of which the operating code
(a) identifies a predetermined packet type; and
(b) specifies in accordance with said predetermined packet type a data field in said data segment for the extraction of data for the application of the respective rule, each single rule including a mask field for controlling the application of the single rule to said data field

15. A classification search engine according to claim 14 wherein said data field is a longword.

16. A classification search engine according to claim 14, wherein:
at least one rule is a multiple rule of which the operating code identifies that rule as a multiple rule and which includes a mask for controlling the application of the multiple rule to the results of the application of a multiplicity of single rules to the data segment.

17. A classification search engine according to claim 14 and further comprising means for determining whether said data packet conforms to said pre-determined type before allowing the application of a rule to the data segment

18. A classification search engine according to claim 14 wherein at least some of the rules each include a field indicating whether the respective rule is an inclusion rule or an exclusion rule.
